(19) United States
(12) Patent Application Publication
(10) Pub. No.: US 2020/0188709 A1
(43) Pub. Date: Jun. 18, 2020

(54) NANOFIBER BASED NASAL FILTER AND A PROCESS OF PREPARATION THEREOF

(71) Applicant: Nanoclean Global Pvt. Ltd., Gurgaon (IN)

(72) Inventors: Kumar Ashwini Agrawal, Delhi (IN); Manjeet Jassal, Delhi (IN); Tushar Vyas, Delhi (IN); Prateek Sharma, Delhi (IN); Jatin Kewlani, Delhi (IN)

(21) Appl. No.: 16/349,561

(22) PCT Filed: Nov. 14, 2017
(86) PCT No.: PCT/IB2017/057092

§ 371 Date: May 13, 2019

(30) Foreign Application Priority Data
Nov. 14, 2016 (IN) 201611031331

(51) Int. Cl. A62B 23/06

(52) U.S. Cl. CPC A62B 23/06

(57) ABSTRACT

The present invention relates to nanofiber based non-insertable nasal filter. The joint geometry of the nasal filter designed enables easy usability and enables application on nasal periphery in one go. The nasal filter provides multilayer filtration for particulate matter between 2.5 PM and 10 PM aerosols with high efficiency and may be used in industries, by traffic police, by commuters for daily use and people with pollen allergy.

### TECHNICAL FIELD

The present subject matter described herein, in general, relates to the field of nasal filters. More particularly, the present invention relates to nanofiber based externally applicable nasal filter and a process for preparation of the same.

### BACKGROUND OF THE INVENTION

Nature maintains a balance between land, water, air and all the living organisms in the world. Any kind of imbalance in the biosphere results in environment pollution. In the past one decade, there has been a quick rise in the number of automobile vehicles to increase in air pollution due to the exhaust fumes of internal combustion engines. The exhaust fumes of diesel engines are largely responsible for the smoke and smog layers in many large towns and cities.

Besides this, several other reasons for increase in the levels of air pollution are rapid industrialization, urbanization, use of moto vehicles, agricultural and nuclear energy programs. Amongst these, motor vehicles using diesel and poor-quality petrol are the major source of air pollution throughout the urban areas. These mainly contribute by emitting hydrocarbons, carbon monoxide, lead, SO₂, nitrogen oxide and particulate matter.

The problem of air pollution has received attention rather late. Various pollution monitoring agencies, routinely monitor ambient air quality. Regular monitoring is generally done for mainly three criteria of pollutants like suspended particulate matter, oxides of nitrogen and SO₂.

Air borne particulate matter (PM) is responsible for serious immediate and long-term impacts on human health because air borne particulates easily reach the deepest recesses of the lungs that damage the respiratory system of human beings. Indoor PM concentrations which are depending upon both indoor and outdoor sources are also responsible for human respiratory allergy because urban people typically spend more than 87% of their time indoor. There are several sources of particulate matter, such as combustion of fossil fuels, automobile exhaust, industrial processes, power plants, tobacco smoke, cooking and natural sources such as volcanic eruption, windblown dust, pollen grains, and particles of soil. Particulate matter lead to serious health hazards in human beings and causing asthma, chronic bronchitis, chronic obstructive pulmonary disease (COPD), irritation of lungs, pneumonia, chronic cough, allergy, headache, fatigue, lung cancer, and premature death. High particle concentration is associated with substantial short term increases in morbidity and mortality.

The size of air borne particles ranges over a wide scale, from 0.005 μm to 100 μm in aerodynamic diameter; although the suspended portion is generally less than 40 μm. PM is classified by their aerodynamic equivalent diameter (AED), and are generally placed in one of the three categories: AED <10 microns=PM₁₀, <2.5 microns=PM_{2.5} and <0.1 microns=PM_{0.1}. Particulate matter is considered coarse when the size is between 2.5 to 10 microns, fine when less than 2.5 microns and ultra-fine when less than 0.1 microns in diameter. Based on these definitions, PM₁₀ includes all pores, fine and ultra-fine particulate matter. PM larger than 10 microns is filtered out through the nose, cilia and mucus of respiratory tract, and are thus of lesser public health concern. Fine particulate PM_{2.5} lead to great risk to human health because they can be breathed more deeply into the lungs and are generally more toxic than larger particles. Accordingly, particulate matter is responsible for serious health problems in human beings and causes morbidity and mortality. In fact, the effects of inhaling this particulate matter have been widely studied in humans and animals which include asthma, lung cancer, cardiovascular diseases, respiratory diseases, premature deliveries, birth defects, and premature deaths.

The World Health Organization (WHO) estimated in 2005 that “fine particulate air pollution (PM (2.5)), causes about 3% of mortality from cardiopulmonary disease, about 5% of mortality from cancer of the trachea, bronchus and lungs, and about 1% of mortality from acute respiratory injections in children under 5 years, worldwide.” Short term exposure at elevated concentrations can significantly contribute to heart disease. A 2011 study concluded that traffic exhaust is the single most serious preventable cause of heart attack in the general public, and is the cause of 7.4% of all attacks.

Thus, in view of the above discussion it is clear that there is a need to control the inhaled particulate matter like airborne germs, allergens, and/or noxious particles.

Filters are being used to maintain air quality and prevent the inhalation of particulate matter. Air filters are utilized to remove aerosol such as dust, pollen, mould and bacteria from the air and are composed of fibrous material. Various chemical additives in the form of adsorbents or catalysts are introduced in chemical air filters to remove other airborne molecular contaminants such as volatile organic compounds releasing hazardous air pollutants like carbon monoxide, sulfur dioxide, hydrocarbons, nitrogen oxides, etc.

Nanofilters are available that provide a membrane separation process which takes in the upper end (in separation size terms) of reverse osmosis, and the lower end of ultrafiltration, covering mwco (molecular weight cut-off) values of 100 to 1000 daltons (lu or da in: is equal to kg: 1.660539040(20)×10⁻²⁷). These membrane type filters, separate liquid and gas by finer and finer fibers, which make filter material. These fibers have diameter measured in nanometers, and are commonly known as nanofibers. These are used to make composite filter media, with a web of nanofibers supported on a coarser substrate. Nanofibers due to their special properties are used for a wide range of applications from medical to consumer products and industrial to high-tech applications for aerospace, capacitors, transistors, drug delivery systems, battery separators, energy storage, fuel cells, and information technology.

Nanofiltration and filtration with nanofibers are sufficiently different. Nanofiltration is a membrane separation process, essentially for liquid phase, because it separates a range of inorganic and organic substances from the solution in a liquid, but by no means entirely, water. This is done by diffusion through a membrane, under pressure differentials that are considerably less than those for reverse osmosis, but significantly greater than those for ultrafiltration. However, nanofiber media has synthetic materials, both organic and inorganic, that are spun from the molten state into fine fibers. Each of these materials can be produced as a random array of fibers as a web, which, in itself, makes a very good filter medium, as long as it is adequately supported on a strong substrate. Electrospinning is the most preferred technique to produce these nanofibers.

The existing nasal filters/masks are summarized in the table below along with the scope of use, effects, and their problems or shortcomings.

| Name | Material | The scope of use and effect | Problem |
|---|---|---|---|
| Medical | Non-woven | For hospital outpatient; | Interception effect of fine |
| masks | fabric | disposable. | particles is poor. |
| | Blended | For the operation room, | Water vapor is poor, High |
| | material | disposable, good sanitary | Respiratory Resistance. |
| | | conditions | |
| Ito | Thickened non- | Dedicated to filter PM2.5 | High Respiratory |
| masks | woven fabric | | resistance and inefficient |
| N95 | Thickened non- | Protection of professional | Respiratory resistance, |
| masks | woven fabric | occupation, preventing flow of | poor comfort |
| | | HINI and microbial particles | |
| R95 | Activated | Used for industrial dust and trace | Respiratory resistance, |
| | carbon | organic gas entrapment | poor comfort |

Thus, it is noted from the above that the existing masks/filters are not capable to provide efficient filtration between 2.5 PM-10 PM particulate, and also develop water vapor which creates difficulty in breathing. Also, these filters are very costly for daily use.

US2008/0264259A1 and U.S. Pat. No. 8,303,693B2 discloses a process of making filter media which includes a fine filter layer having a plurality of nanofibers and a coarse filter layer having a plurality of microfibers attached to the fine filter layer. The nanofibers were produced either by using syringe Electrospinning or by melt blown process.

US2010/0307119A1 discloses the concept of multilayer nanofiber filter media for improved filtration of submicron particles with less pressure drop.

3254/MUM/2013 discloses a process for preparing a nanofiber based antimicrobial face mask for protection against viruses, by using composite filter media having antimicrobial nanoparticle filled nanofiber layer deposited on the surface of nonwoven substrate and said face mask has more than 99% virus filtration efficiency.

The existing nasal filters/inserts are mostly constructed to have two oval shaped separate filters for each nasal cavity, which are capable to filter particulate material like air borne germs, allergens and/or noxious particles.

However, the aforesaid filters are not capable of efficiently filtering between 2.5 PM and 10 PM and absorb harmful gases. They provide more than 1 mbar pressure gradient, which creates hindrance for comfortable breathing. Examples of such filters are First Defense Nasal Filter, Rhinix inserts, Sanispire inserts, etc. Also, the existing masks are not capable to provide efficient filtration of 2.5 PM, and tend to develop water vapor which further adds to the difficulty in breathing.

Moreover, the existing filters not only possess the aforementioned drawbacks but are also very costly and inconvenient for daily use by consumers, as they are either too bulky or are not appropriately designed for easy wearability in the nasal cavities. Also, due to their high cost, they are unfit for short term and frequent usage. Examples of such filters are medical masks (Non-woven fabric, Blended material), Ito masks (Thickened non-woven fabric). N95 masks (Thickened non-woven fabric), R95 (Activated carbon), etc.

Further, existing disposable non-woven face masks gives a rejection ratio of 32.9% at a pressure drop 0.29 KPa.

Furthermore, medical masks made from non-woven fabric have poor interception effect of fine particles, whereas those made up of blended material have high respiratory resistance. Thickened non-woven fabric masks like N95 also have poor comfort.

Also, the broadly nose shapes can be divided into two shapes, round nose shapes and slotted nose shape. In view of this, the design suggested for a nasal filter should be such that it fits almost all nose shapes perfectly and at the same time is less visible from aesthetic point of view.

Hence, in view of the above drawbacks, there is a need to design and develop a nasal filter which is cost-effective, easy to use and provides efficient filtration for particulate matter between 2.5 PM and 10 PM while maintaining a minimum pressure difference along the filter for easy breathing. Moreover, it is desired to develop a nasal filter that not only provides protection from particulate matter, but is also comfortable to use. The nasal filter proposed by the present invention overcomes the limitation of the prior art by providing a novel and aesthetically improved nanofiber based nasal filter design.

The above-described deficiencies of today's nasal filters are merely intended to provide an overview of some of the problems of conventional systems, and are not intended to be exhaustive. Other problems with conventional systems and corresponding benefits of the various non-limiting embodiments described herein may become further apparent upon review of the following description.

### OBJECTS OF THE INVENTION

The main object of the present invention is to provide a nanofiber based nasal filter for easy application and adapted to suit different nose shapes.

Another object of the present invention is to provide a nasal filter which can filter out particulate matter between 2.5 PM and 10 PM.

Another object of the present invention is to provide a nasal filter with nanofibers to facilitate nanofiltration of gaseous contaminants with minimum pressure difference along the filter.

Yet another object of the present invention is to provide a nasal filter with nanofibers which is easy to apply, use and produce no skin sensitivity issues.

Still another object of the present invention is to provide a nasal filter capable of providing multilayer filtration with high efficiency.

Other aspects, advantages, and salient features of the invention will become apparent to those skilled in the art from the following description, which, taken in conjunction with the annexed drawings, discloses exemplary embodiments of the invention.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

The present invention relates to nanofiber based externally applicable nasal filter and a process of preparation thereof. The design of the present nanofiber based externally applicable nasal filter is practically suitable for all nose types regardless of nose orientation.

The nasal filter of the present invention has a joint geometry for both the nostrils. Joint geometry enables better user handling as more area is available to use both the hands. Further, it also enables application on nasal periphery in one go.

The inventors of the present invention have designed the said shape based on a study of different nose shapes. The said design has been designed to reduce the visibility of nasal filter on nasal periphery to the minimum and for easy adaptability to different nose shapes. The columella of the nose (13) is almost a straight shaped structure with low radius of curvature whereas sills (12) and sideway alae (14) are curved with high radius of curvature. Hence, the slotted nose shape structure is the amalgamation of 3 curves based on the curvature of columella, alae and sills part of the nostrils. With highest radius of curvature for sills, lower for alae and lowest for columella, for the nasal filter slotted nose shape, R1>R2>R3. The height and the width of the nasal filter has been assigned on the basis of average adult nasal periphery shape. Thus, the design of the present nasal filter is adjustable on different nose shapes.

This not only adds to the convenience of the user but also to the economics of production. In addition to this, the bridge width is large enough to provide strength and small enough to provide flexibility for angle change.

In the present invention, electrospinning technique has been adopted for production of nanofiber at pilot to commercial scale, for producing very uniform nanofiber layer of approximately 1 to 2 orders of magnitude smaller than melt-blown fibers. Most particularly, the present invention relates to designing a Nasal filter with multilayer filtration which filters particulate matter between 2.5 PM to 10 PM aerosols with high efficiency. The present nasal filters have acceptable breathability and may be used in industries, by traffic police, by commuters for daily use and people with pollen allergy.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1 illustrates a front view of the nasal filter in accordance with an embodiment.

FIG. 2 illustrates an exploded bottom view of a nasal filter in accordance with an embodiment.

FIG. 3 illustrates a typical nostril with the different peripheral portions.

FIG. 4 illustrates an exemplary embodiment of the nasal filter in accordance with the present invention.

FIG. 5 illustrates the packaging of the nasal filter in accordance with an embodiment of the present disclosure.

FIG. 6 illustrates the application of the present nanofiber based nasal filter over a user's nose.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

The following description with reference to the accompanying drawings is provided to assist in a comprehensive understanding of exemplary embodiments of the invention. It includes various specific details to assist in that understanding but these are to be regarded as merely exemplary.

While the invention is susceptible to various modifications and alternative forms, specific embodiments thereof have been described in detail below. It should be understood, however that it is not intended to limit the invention to the particular forms disclosed, but on the contrary, the invention is to cover all modifications, equivalents, and alternatives falling within the spirit and the scope of the invention. In addition, descriptions of well-known functions and constructions are omitted for clarity and conciseness.

The terms and words used in the following description and claims are not limited to the bibliographical meanings, but, are merely used by the inventors to enable a clear and consistent understanding of the invention. Accordingly, it should be apparent to those skilled in the art that the following description and embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect and the characteristic it was intended to provide.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The present invention relates to nanofiber based nasal filters and a process of preparing the nasal filter thereof. Most particularly, the present invention relates to designing a Nasal filter with multilayer filtration and capable of fitting on different nose shapes which filters out particulate matter between 2.5 PM and 10 PM with high efficiency. Further, this technology may as well be used by industries for dust and trace organic gas entrapment.

The nasal filter in accordance with the present invention is a nanofiber based nasal filter having nanofiber based filter to be applied on nostrils for filtering the air breathed in by a user. The nasal filter as disclosed herein is adapted to be secured externally onto a user's nostrils by use of an adhesive layer.

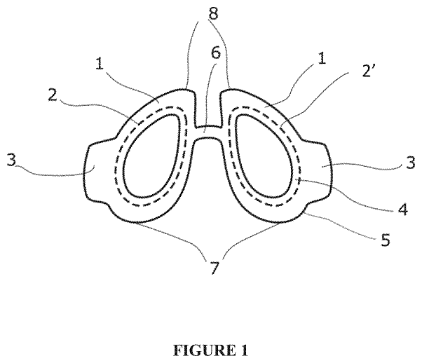

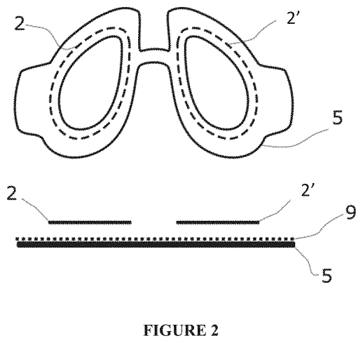

Referring to FIG. 1 and FIG. 2, the nasal filter as disclosed herein has two filter media, namely a first filter media (2) and a second filter media (2′), one each of the left and the right nostril. The first filter media and the second filter media are referred to generally as the filter media in foregoing description. Each of the filter media has a filter and a peripheral portion. The filter may be a nanofiber based filter. The peripheral portion forms a frame of the nasal filter and provides support for the filter. As shown in FIG. 1, each of the peripheral portion is designed and configured to cover a nostril. The overall width and dimensions of the peripheral portion are such that the peripheral portion abuts the nostril when the nasal filter is applied. The peripheral portion in the embodiment as shown is made of a slotted nose shape. The slotted nose shape ensures that the nasal filter can be applied to a wide range of shapes of nose. The nose shape of the nasal filter in accordance with the present disclosure is explained in the foregoing description.

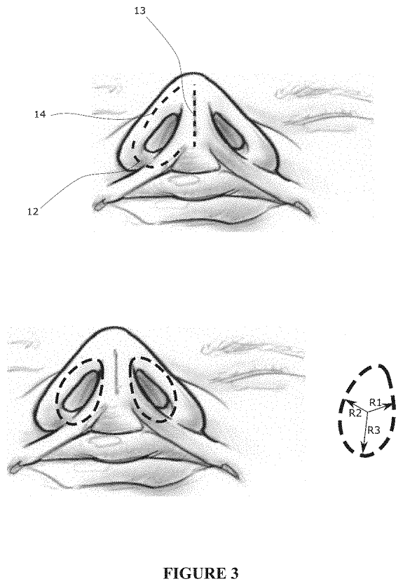

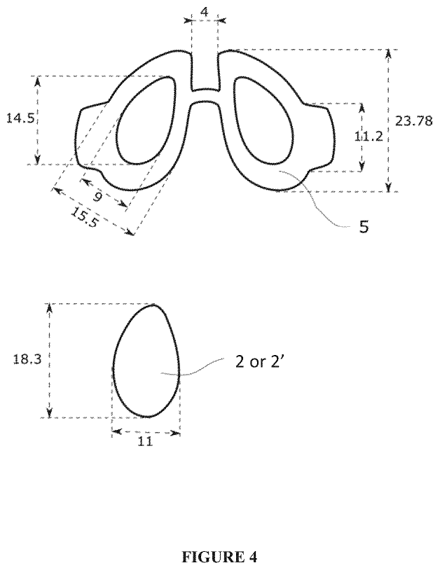

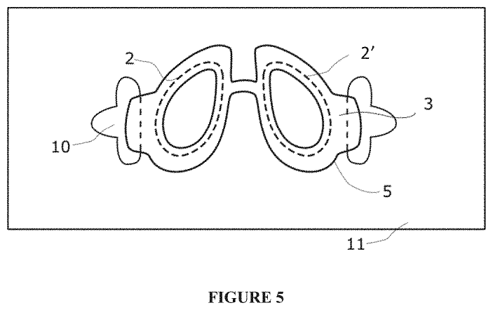

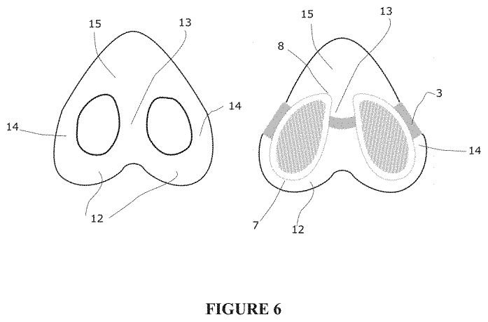

The shape of a nostril majorly has three portions. As shown in FIG. 3, the nostril has a sill, an ala and a columella. The shape of the filter media of the nasal filter is configured according to these peripheral portions of a nostril. FIG. 5 broadly illustrates shape of the filter media in accordance with the present disclosure as compared to a shape of the nostril. It is to be understood that the shape of nostril is only shown as an example. The nasal filter as disclosed herein may be applied to different shapes of noses. Accordingly. FIG. 6 shows a shape of the filter media when applied to the nostril. As shown the shape of the filter media is broadly covering the nostril and the shape is adapted such that different other shapes of nostril may be substantially covered by the filter media when the nasal filter is applied by a user. Further as shown in FIG. 3, the periphery of the filter media can broadly be divided into three portions having different radius of curvature. R1 indicates radius of curvature of the portion of the periphery that is configured to about a columella of the nose. Since the columella is generally a straight portion as shown in FIG. 3, R1 is substantially equivalent to radius of curvature of a straight line. Further, R2 indicates a radius of curvature of a portion of the periphery that is configured to abut an ala or wing portion of the nostril. The wing of a nostril has a radius of curvature lesser than the columella, and R2 is provided accordingly. Further, R3 indicates the portion of the periphery that is configured to about a sill portion of a nostril, which has the least radius of curvature. Thus broadly, the relationship between R1, R2 and R3 can be described as R1>R2>R3. The preferred measurements may be readily achieved in accordance with general dimensions (in millimeters) as illustrated in FIG. 4. It may be understood by a person skilled in the art that the dimensions as shown in FIG. 4 may be slightly and proportionally altered to arrive at an alternate embodiment of the nasal filter as disclosed herein.

Further, the peripheral portion defines a hole configured for mounting the filter on the peripheral portion. The shape of the hole and the filter are configured such that a peripheral width of the filter overlaps with a peripheral width of the peripheral portion defining the hole, as shown with dotted lines in FIG. 6. In the embodiment as shown, the peripheral portion is provided with a layer of adhesive to mount the filter and to support the filter in its place on the peripheral portion. Any alternative suitable means may be used to secure the filter on the peripheral portion, for example, the filter can be secured using weaving or by hot stamping, etc. Accordingly, the filter is attached to the peripheral portion along this overlapping portion and this way the filter is supported on the peripheral portion. A layer of adhesive may be provided along the overlapping portion for mounting of the filter on the peripheral portion.

Further, when the filter is mounted on the peripheral portion, a width of the peripheral portion extends outward from the outer periphery of the filter. The peripheral portion is provided with a layer of adhesive (4) in order to stick the peripheral portion on the skin surrounding the nostril when the nasal filter is applied. The adhesive may be any known adhesive suitable for application on skin. In addition, an odourless adhesive may preferably be used to avoid any unpleasant odour as the nasal filter is to be applied to the nose. Also, in an embodiment, an adhesive layer with a mild pleasant fragrance may be used. The width of the peripheral portion can be optimized to achieve proper pasting on the nose. The width may also be altered according to the strength of adhesive used. A stronger adhesive may require lesser width of peripheral portion in order to secure the nasal filter on nose when applied.

In the embodiment as shown, the adhesive provides the binding force and strength for filter media to stick with adhesive film and for nasal filter to stick with nasal periphery (1). Hence, adhesive serves dual purpose.

Further, the peripheral portion in the embodiment as shown is in form of a transparent or translucent film. The film may further be made of any suitable material such as plastic, cloth, fiber or any other suitable material.

Further, as shown in FIGS. 1,4 and 5, a flap (3) extend from a periphery of the peripheral portion from each of the filter media. Referring to FIG. 1, the flaps are provided extending from a portion of the peripheral portion that is configured to abut the wing or ala of nose. The flaps are configured such that the flaps stick to the outer portion of the ala of nose and further aid in securing the nasal filter on the nose firmly and for long duration. It is to be noted that the pasting of the nasal filter on the nose should be strong enough to resist the wind blast generated from the nose cavity during breathing. Also, the pasting should be configured such that the nasal filter is not getting drawn inside the nasal cavity while breathing in. The provision of flaps further aids in easy handling of the nasal filter while applying or removing the nasal filter from the nose, as the flap may provide for a wider surface area for holding the nasal filter during application or removal.

During application or removal, use of an infected to dirty hand may contaminate the nasal filter. Which may lead to the user exposed to pathogens or other harmful contaminants. Moreover, frequent touching of the adhesive layer on the nasal filter may reduce effectiveness of the adhesive layer and hamper reusability of the nasal filter. The flaps can be used to help the user to avoid touching the other portion of the nasal filter while application or removal, thus further reducing changes of spoiling the nasal filter during application/removal. The flaps provided at the periphery of the first and the second filter media provide an area for the user to hold the nasal filter. This ensures ease of application and provides an additional area for the holding of nasal filter with the nasal periphery, thereby increasing its reusability. Accordingly, the size and position of the flap is based on an analysis of the application process of the nasal filter.

FIG. 4 indicates dimensions in millimeters of the flap as an example. Slight variation in dimensions may be used as suitable.

Further, as shown in FIGS. 1, 2, 4, 5 and 6, the nasal filter has a bridge (6) connecting the two-filter media. The bridge ensures that the two-filter media remain together during application or handling of the nasal filter. As shown, the bridge has very limited dimensions compared to the overall dimension of the nasal filter. The bridge keeps the two-filter media together. Further, the minimal dimensions of the bridge ensure enough flexibility of the bridge for proper positioning of the filter media on the nostril during application of the nasal filter. In the embodiment as shown, the width of the bridge is less than half the width of columella portion (R1) of the peripheral portion of the nasal filter. The bridge may merely connect the two filter media with each other. However, the bridge may also be provided with an adhesive layer further aiding in securing the nasal filter on the columella portion of the nose.

The flaps, peripheral portion and the bridge, collectively hereinafter referred to as the frame, may be formed integral to each other. For ease of manufacturing the frame may be stamped out directly from a sheet of material which has an adhesive layer. In an embodiment the material may be polyurethane. The filter may be pasted on the sheet either before or after stamping the frame.

Further, the nasal filter may be packaged compactly and for a convenient use as disclosed herein. As shown in FIG. 5, the nasal filter may be packaged as pasted removably on a sheet of a packaging paper or plastic. When a user has to use the nasal filter, the user may simply separate the nasal filter away from the packaging paper sheet by using a thumb or a finger to separate the flap portion first, then the nasal filter may be pulled away by holding either of the flaps. Further, in the embodiment as shown in FIG. 5, the packaging may include a release paper (10) pasted on the. A portion of the release paper may be pasted on the flaps while another portion may be free for a user to hold the release paper and pull away the filter from the packaging paper (11). The release paper may also be used to apply the nasal filter on the nose while holding the release paper during application of the nasal filter on the nose. Once it is applied, the release paper may be pulled away from the flaps. This way any direct contact with the nasal filter may be avoided. In an embodiment, the release paper for the flap is positioned between the flap (3) and the packaging paper for the nasal filter.

Accordingly, the shape of the flaps has been designed for use in removal of nasal filter from packaging with the use of thumb and index finger. Hence, the width of the flap may be as per average thumb size. While sticking the nasal filter on the nasal periphery, lower part of the nasal filter (R3), can be pasted on the nasal sills (12) first so that filter media properly covers the nasal cavity. Hence, the flaps have been deliberately placed on the lower side of the nasal filter to ensure proper application.

FIG. 4 illustrates an exemplary embodiment in accordance with the present invention and should not be construed to limit the invention to the specific size and measurements shown in the said figure. The size and measurements may vary based on different nasal shapes and sizes.

In another embodiment, each of the first and second filter media are held by the adhesive (5) layer of the peripheral portion.

In another embodiment, the filter is held by the adhesive layer on the peripheral portion.

In yet another embodiment, the first and second filter media are slotted nose shaped.

In another embodiment, the release paper for the flap is positioned between the flap (3) and the release paper for the nasal filter.

In an embodiment, the adhesive is a medical grade adhesive (9).

In an embodiment, the peripheral portion is made of polyurethane.

In a preferred embodiment, the bridge (6) and peripheral portion is made of a transparent material.

In a preferred embodiment, the filter layer is made up of a nanofiber material which may be electrospunned onto a base material.

In yet another embodiment, the base material is a porous and non-woven material.

In an embodiment, the nanofiber based nasal filter is bio-degradable and bio-disposable.

In yet another embodiment, the nanofiber based nasal filter has an additional pocket/cavity for an adsorbent.

In an embodiment, the length of the bridge (6) is 4 mm which is an average size of adult human columella.

In another embodiment, the filter angle is adjustable and has been rotated by a default angle of 30 degrees with respect to columella, which was found to be the most common angle of nasal cavity and columella.

In an embodiment, the nanofiber used for preparation of the filter media may be prepared by electrospinning method involving the steps of electrospinning a polymer solution, melt-blown polymers, electrospinning polystyrene or polyvinyl chloride from solutions in tetrahydrofuran (THF), polyethylene-terephthalate (PET) and polyethylene-naphthalate (PEN) over a suitable base material.

In another embodiment, the base material used in preparation of nanofiber filter may be a porous and non-woven material to provide support and mechanical strength to nanofiber layer, for example spunlaced polyester fabric, SMS (spunbond meltblown spunbond), polyethylene, cotton voile, cotton non-woven, etc. The substrate may include but not limited to microfibers made up of polyethylene, glass, cellulose acetate, activated carbon fiber or combinations thereof.

In yet another embodiment, the polymers may include but not limited to polyolefin, polyacetal, polyamide, polyester, cellulose ether and ester, polyalkylene sulfide, polyarylene oxide, polysulfone, modified polysulfone polymers, nylon, polystyrene, polyacrylonitrile, polycarbonate and mixtures thereof.

In another embodiment, the proposed nasal filter shape has width of a round nose shape and length of a slotted nose shape, and hence a single size can cater to all nose shapes. Various configurations of the present respiratory filters may be construed from the disclosure.

In an embodiment, the outer periphery of the adhesive media contains an extended flap so as to provide additional area for person to hold the nasal filter properly and place it on the nose. The extended flap helps to improve the life of the filter media by providing additional area for the adhesion of nasal filter to the nose and hence longer durability for oily skin type.

The packaging paper is used to stick the nanofiber based nasal filter for the packaging. An additional release paper for flap has been introduced. This enables an easy removal of the nasal filter from the packaging paper and user is not required to scratch the edge of the nasal filter to release it from the release paper. Also, during application, the user may hold the nasal filter directly from release paper for flap and hence fingers do not come in contact with the adhesive on the flap and hence no contamination of adhesive will occur which is useful for nasal skin safety as the nasal filters are used in daily routine.

Another important aspect of the release paper for flap is easy removal of nasal filter from the packaging paper for nasal filter. This ensures no extra forces to be applied on the edges of the nasal filter as observed in other nasal filters. Hence, due to non-existence of undesirable tension, the shape of the nasal filter remains intact and is not distorted.

Since the nasal filter is designed to fit the nasal periphery with least visibility, it has a specific method of application to achieve the desired results. The user has to hold the release paper of the flap and remove it gently from the packaging paper of nasal filter. After complete removal, the user can use both the hands as a single unit nasal filter and flaps provide sufficient area for handling. The adhesive side has to be upright in position.

The rear part of the nasal filter (7) needs to be sticked to the sills first to ensure that filter media coincides exactly with the nasal cavity. One can adjust the angle while sticking the rear end to the sills as per the nasal shape. Further, one has to press from the alae to the nasal tip (15) using thumbs and then to columella to ensure complete sealing. After application, the user can remove the release paper from the flap and then seal the flap. This method gives perfect placement of the nasal filter in each application.

The present invention provides a composite nanofiber based disposable respiratory filter that filters out airborne particulate matter (PM), bacteria and viruses (preventing flow of HINI and microbial particles). The nasal filter may comprise a cavity/pocket of one or more adsorbents to filter out hazardous air pollutants like carbon monoxide, sulfur dioxide, hydrocarbons, nitrogen oxides, etc. In an embodiment, the adsorbent used in the cavity/pocket of the nasal filter are activated charcoal fibers, carbon fibers, cellulose acetate etc.

The present nasal filters have acceptable breathability and may be used in industries, by traffic police, by commuters for daily use and people with pollen allergy. The present nasal filter is a non-insertable nasal filter which is hypo-allergenic and self-adhering. Further, this technology may as well be used by industries for dust and trace organic gas entrapment.

The nanofiber based filter media of the present invention may be produced using well known methods such as electrospinning, which results in fibers of approximately 1 to 2 orders of magnitude smaller than melt-blown fibers.

The nasal filter of the present invention may be used for filtration of particulate matter between 2.5 PM to 10 PM with reduced pressure difference for easy breathing. In addition to this, the present nasal filter design is cost effective, easy to construct and simple for daily use. Besides this, the nasal filter of the present invention provides an easy single membrane nasal filter for both nasal cavities with user compliant/medical grade adhesive.

1. A nasal filter comprising:
i) a first filter media (2) and a second filter media (2′), wherein each of the first and the second filter media comprises:
a filter made of nanofiber, the filter adapted to substantially cover a nostril;
ii) a peripheral portion surrounding the filter and configured to adhere to a periphery of the nostril and hold the filter over the nostril; and
iii) a flap (3) extending from the peripheral portion of each filter media and configured to adhere to an ala of nose to hold the nasal filter with the nose;
iv) wherein the peripheral portion and the flap are provided with a layer of adhesive (5) for adhering the nasal filter over a nose; and a bridge (6) connecting the first filter media with the second filter media and configured for abutting a columella of nose.

2. The nasal filter as claimed in claim 1, wherein the nasal filter comprises:
a packaging paper (11) adhered to the peripheral portion of the nasal filter for packaging of the nasal filter.

3. The nasal filter as claimed in claim 1 or claim 2, wherein the nasal filter comprises:
a release paper (10) adhered to the flap and configured to be held by a user for applying the nasal filter on the nose.

4. The nasal filter as claimed in any of the preceding claims, wherein the width of the bridge is lesser than half the width of the nasal filter.

5. The nasal filter as claimed in claim 4, wherein each of the first and second filter media are held by the adhesive layer of the peripheral portion.

6. The nasal filter as claimed in any of the preceding claims, wherein the filter is held by the adhesive layer on the peripheral portion.

7. The nanofiber based filter as claimed in claim any of the preceding claims, wherein the length of the bridge is preferably 4 mm.

8. The nanofiber based filter as claimed in any of the preceding claims, wherein the first and second filter media are slotted nose shaped.

9. The nanofiber based filter as claimed in any of the preceding claims, wherein a periphery of the filter comprises:
an ala portion; and
a columella portion;
wherein the ala portion is inclined at an angle of 30 degrees with respect to the columella portion.

10. The nasal filter as claimed in claim 3, wherein the release paper for the flap is positioned between the flap (3) and the release paper for the nasal filter.

11. The nasal filter as claimed in any preceding claims, wherein the adhesive is a medical grade adhesive.

12. The nasal filter as claimed in any preceding claims, wherein the peripheral portion is made of a transparent material.

13. The nasal filter as claimed in any of the preceding claims, wherein the bridge is made of a transparent material.

14. The nasal filter as claimed in any of the preceding claims, wherein the peripheral portion is made of polyurethane.

15. The nasal filter as claimed in any of the preceding claims, wherein the filter layer is made up of a nanofiber material.

16. The nasal filter as claimed in any of the preceding claims, wherein the nanofiber material may be electrospunned onto a base material.

17. The nasal filter as claimed in any of the preceding claims, wherein the base material is a porous and non-woven material.

18. The nasal filter as claimed in any of the preceding claims, wherein the nanofiber based nasal filter is bio-degradable and bio-disposable.

19. The nasal filter as claimed in any of the preceding claims, wherein the nanofiber based nasal filter has an additional pocket/cavity for an adsorbent.
